(19) United States
(12) Patent Application Publication
(10) Pub. No.: US 2016/0379103 A1
(43) Pub. Date: Dec. 29, 2016

(54) Heat-resistant RFID device

(71) Applicant: Te Kim Chou, Hsinchu (TW)

(72) Inventor: Te Kim Chou, Hsinchu (TW)

(21) Appl. No.: 15/261,987

(22) Filed: Sep. 11, 2016

(30) Foreign Application Priority Data
Dec. 8, 2015 (TW) 104219648

(51) Int. Cl. G06K 19/077

(52) U.S. Cl. CPC G06K 19/0772; G06K 19/0773

(57) ABSTRACT

A heat-resistant RFID device is provided with a heat-resistant container including a first space and a cover; two heat-resistant first receptacles in the first space, each heat-resistant first receptacle including a cavity facing the cavity of the other heat-resistant first receptacle; and a heat-resistant second receptacle in the cavities and including an open second space, an RFID tag in the second space, and a heat-resistant adhesive filled in the second space and covered the RFID tag to fasten the RFID tag in the second space.

### BACKGROUND OF THE INVENTION

1. Field of the Invention

The invention relates to radio-frequency identification (RFID) and more particularly to a heat-resistant RFID device.

2. Description of Related Art

It is not often but not impossible that employees of a crematorium may mistakenly give the cremated remains to relatives not related to the dead person.

Thus, the need for improvement still exists.

### SUMMARY OF THE INVENTION

It is therefore one object of the invention to provide a heat-resistant RFID device comprising a heat-resistant container including a first space and a cover; two heat-resistant first receptacles in the first space, each heat-resistant first receptacle including a cavity; a heat-resistant second receptacle in the cavities and including an open second space, an RFID tag in the second space, and a heat-resistant adhesive filled in the second space and covered the RFID tag to fasten the RFID tag in the second space.

The above and other objects, features and advantages of the invention will become apparent from the following detailed description taken with the accompanying drawings.

### BRIEF DESCRIPTION OF THE DRAWINGS

FIG. 1 is an exploded view of a heat-resistant RFID device according to the invention;

FIG. 2 is a longitudinal sectional view of the heat-resistant first receptacle; and

FIG. 3 is a cross-sectional view of the heat-resistant second receptacle.

### DETAILED DESCRIPTION OF THE INVENTION

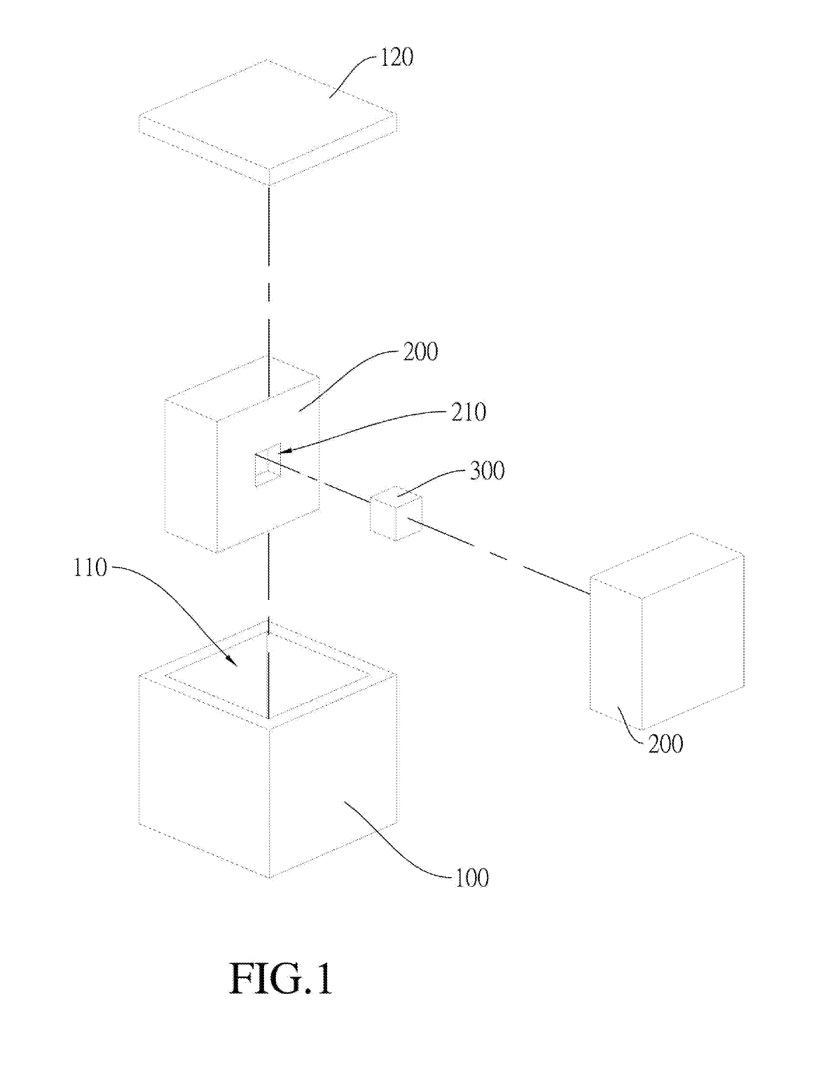

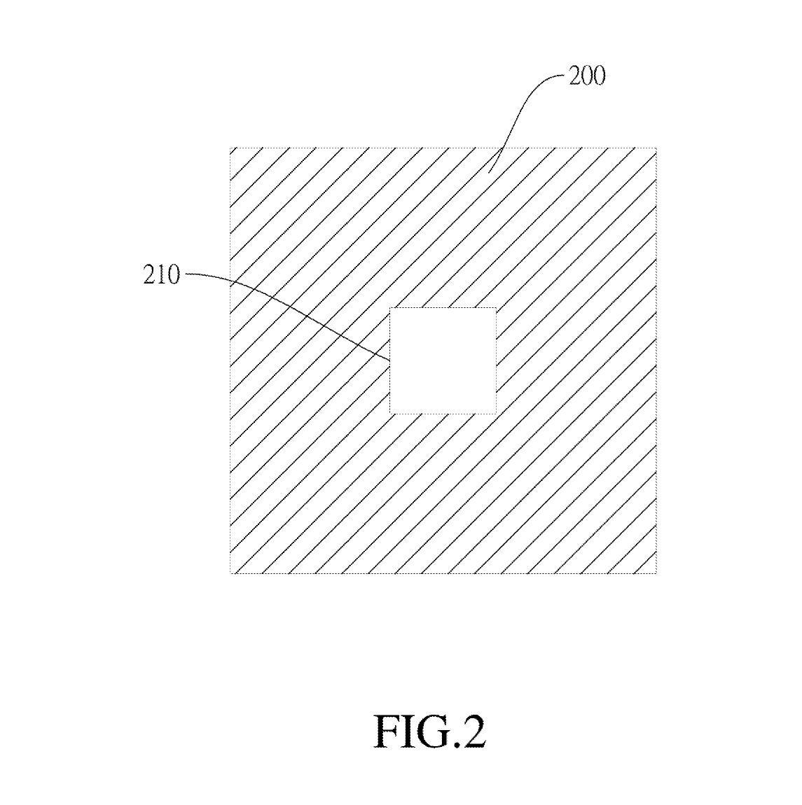

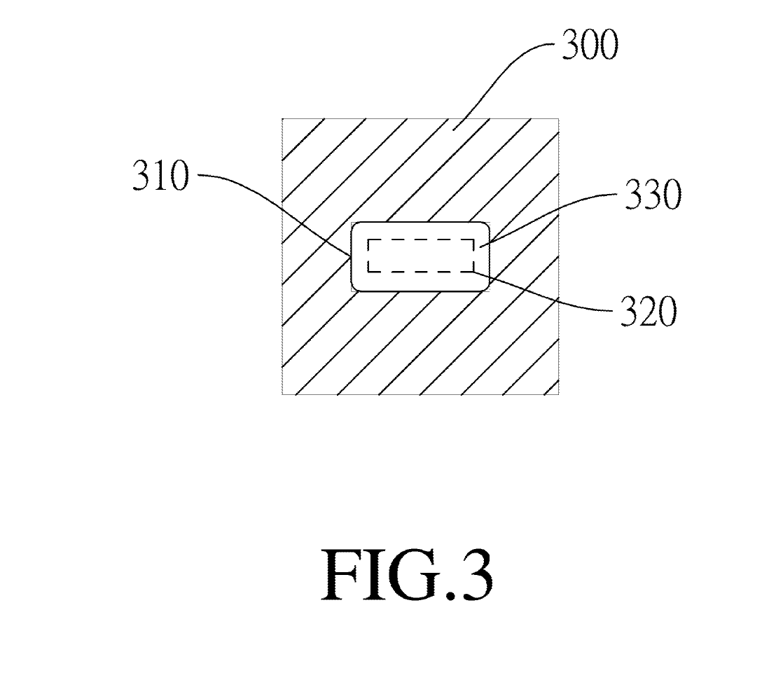

Referring to FIGS. 1 to 3, a heat-resistant RFID device in accordance with the invention comprises the following components as discussed in detail below.

A heat-resistant container 100 includes a space 110 and a cover 120. Two heat-resistant first receptacles 200 are disposed in the space 110. Each heat-resistant first receptacle 200 includes a cavity 210 facing the cavity 210 of the other heat-resistant first receptacle 200. A heat-resistant second receptacle 300 is disposed in the cavities 210 and includes an internal space 310 opening to the bottom, an RFID tag 320 disposed in the space 310, and a heat-resistant adhesive 330 filled in the space 310 and covered the RFID tag 320 to fasten the RFID tag 320 in the space 310.

Preferably, the container 100 is formed of calcium silicate.

Preferably, the heat-resistant first receptacle 200 is formed of at least one of ceramic fiber board, calcium silicate, asbestos, and heat-resistant cement.

Preferably, the heat-resistant adhesive 330 is formed of at least one of heat-resistant glue and ceramic adhesive.

Preferably, the heat-resistant first receptacle 200 and the heat-resistant adhesive 330 each is resistant to a temperature range of 1,000-1,260° C.

Preferably, the RFID tag 320 is resistant to a temperature range of 880-1,000° C. for 60-90 minutes.

In an exemplary application, the heat-resistant RFID device can be placed in a coffin beside a dead person. Next, the dead person in the coffin and the heat-resistant RFID device are cremated. The heat-resistant RFID device can withstand the high temperature about 870° C. in the cremation. After the cremation, an RFID reader can be used to tract the RFID tag 320 in the heat-resistant RFID device in order to identify ashes of the dead person. This can prevent the cremated remains from being identified erroneously.

While the invention has been described in terms of preferred embodiments, those skilled in the art will recognize that the invention can be practiced with modifications within the spirit and scope of the appended claims.

What is claimed is:

1. An RFID device comprising:
a container including a first space and a cover;
two first receptacles disposed in the first space, each first receptacle including a cavity facing the cavity of the other first receptacle; and
a second receptacle disposed in the cavities and including an open second space, an RFID tag disposed in the second space, and an adhesive filled in the second space and covered the RFID tag to fasten the RFID tag in the second space.
